(19) United States
(12) Patent Application Publication
(10) Pub. No.: US 2008/0044612 A1
(43) Pub. Date: Feb. 21, 2008

(54) Self-stick-on Plastic Film

(76) Inventor: David C.T. Jour, Taipei (TW)

Correspondence Address: Richard Chen, 7F., No. 122 Sung Chiang Rd., Taipei, omitted

(21) Appl. No.: 11/464,833

(22) Filed: Aug. 16, 2006

(51) Int. Cl. B32B 33/00

(52) U.S. Cl. 428/42.1; 428/40.1

(57) ABSTRACT

The invention is related to a self-stick-on plastic film that can replace highlighter pens. Structurally, it consists of a self-stick-on plastic film stack that is made of multiple pieces of self-stick-on transparent plastic film that has fluorescene colors in red, orange, yellow, green and blue to add aesthetic and decorative effect and attraction; an internal case that is made of a plate with two sides curving up toward center to form a concave holder and can accomodate more than one stack of plastic film, and an external case that is similar in appearance but has a little larger concave holder than the internal case and can accomodate the internal case. So users can easily and conveniently peel off the self-stick-on transparent highlighter plastic film to gain convenience in use. The self-stick-on plastic film has different highlighting colors to replace highlighter pen. Their surface can be printed with easy and identifiable symbols for users to gain aesthetic feeling and identify different documents.

### BACKGROUND OF THE INVENTION

1. Field of the Invention

The invention is related to a self-stick-on plastic film that can replace highlighter pen. Especially, it provides convenience as users are peeling off the film. The self-stick-on plastic film also provides decorative and aesthetic effect and delivers added value through multiple function.

2. Description of the Prior Art

Self-stick on memo pads are a convenient and useful product. It mainly applies special adhesive backing on the side close to the edge of a small piece of paper. The adhesive backing has proper tackiness, so no residual adhesive remains on the object when the paper is removed from the object. People use self-stick memo pads to pass out messages for quick response with great convenience. With wide spreading of education and advancement in knowledge, people in all fields have got used to self-stick memo pads for noting instant and important things. It has become a necessary product that people would use everyday.

Traditional self-stick memo pads is made of a stack of memo paper, and put inside a holder. In use, the top paper is removed first. There is proper amount of adhesive applied between each piece of paper, so proper binding force is provided. Because self-stick memo pads are very light, users tend to lift up a thick stack of paper and cause inconvenience.

Besides, the self-stick memo pads holder usually takes simple geometry without design for fixation or portability.

Further, traditional self-stick memo pads holder lacks innovative design to attract consumers, so it loses profitability and market competitiveness.

Further, highlighter pens are similar to self-stick-on memo pads in noting important messages. But for some documents or specific materials, highlighter pens do not apply. This is especially true when the same document cannot be marked too much or too colorful. Otherwise, the document will be messed up or hard to read.

In view of the shortcomings for the traditional self-stick memo pads, the inventor was dedicated to improving its design and invented self-stick-on transparent highlighter plastic film to replace highlighter pens.

### SUMMARY OF THE INVENTION

The main objective of the invention is to provide a self-stick-on transparent highlighter plastic film with simple use and convenient peelability to replace highlighter pens and improve the ease of use and multiple functionalities.

Another objective of the invention is to provide a self-stick-on transparent highlighter plastic film to replace highlighter pens, so its internal case and external case can provide ease of peeling the self-stick-on transparent highlighter plastic film and aesthetic appearance. Especially, the case can use its hanging tab with a round hole on one side or a long hanging tab with a round hole and a long hole on the other side to bind itself to a portable notebook or planner through spirals to achieve fixation effect and convenience of instant use.

Another objective of the invention is to provide a self-stick-on transparent highlighter plastic film that is more aesthetic and attractive than traditional memo pad holder to replace highlighter pens.

To achieve the above objectives, the self-stick-on transparent highlighter plastic film in the invention structurally consists of a plastic film stack made of multiple pieces of self-stick-on transparent plastic film that has fluorescene colors in red, orange, yellow, green and blue etc., an internal case that is a plate with two sides curving up toward center to form a concave holder and can accomodate more than one stack of plastic film, and an external case that can accomodate the internal case and is similar in appearance but a little larger than the internal case.

Besides, the internal case can use its hanging tab with a round hole on one side or a long hanging tab with a round hole and a long hole on the other side to bind itself to a portable notebook or planner through spirals to achieve fixation effect and convenience of instant use.

The following provides detailed description for the embodiments of the invention with illustration. With this, it is hoped the patent examiners gain further understanding of the functions and features for the invention.

### BRIEF DESCRIPTION OF THE DRAWINGS

FIG. 1 is a three-dimensional disassembly diagram for a preferred embodiment for the invention.

FIG. 2 is a three-dimensional exterior structural diagram for a preferred embodiment for the invention.

FIG. 3 is an illustration for a preferred embodiment in use for the invention.

FIG. 4 is a three-dimensional disassembly diagram for another preferred embodiment for the invention.

FIG. 5 is a three-dimensional exterior structural diagram for another preferred embodiment for the invention.

FIG. 6 is an illustration for another preferred embodiment in use for the invention.

FIG. 7 is an illustration for another preferred embodiment in use for the invention.

FIG. 8 is an illustration for another preferred embodiment in use for the invention.

FIG. 9 is an illustration for another preferred embodiment in use for the invention.

### DETAILED DESCRIPTION OF THE PREFERRED EMBODIMENT

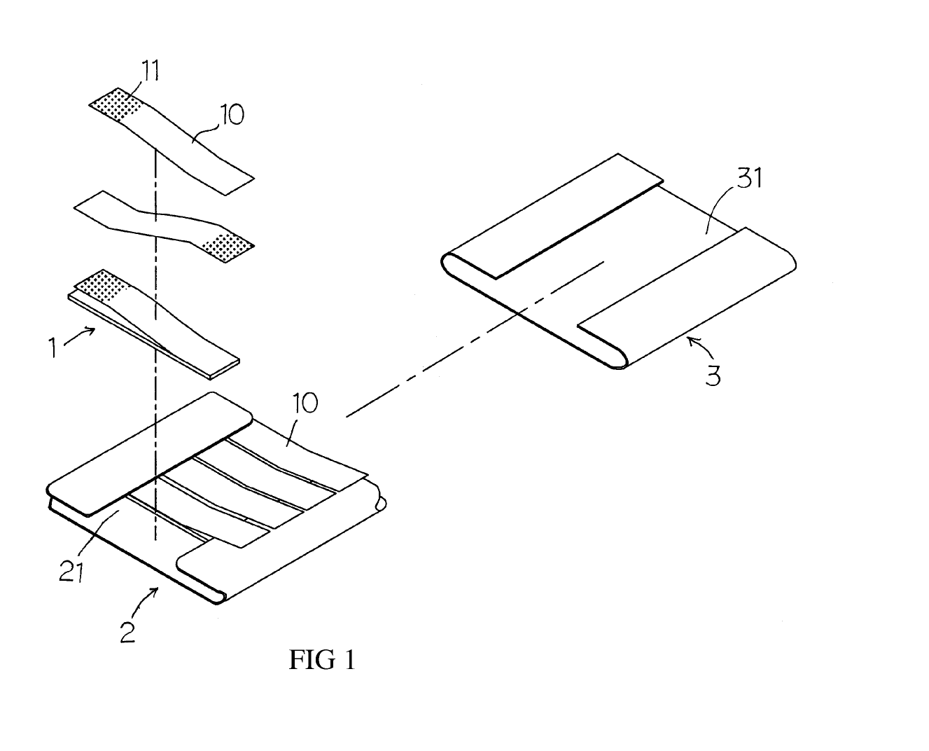

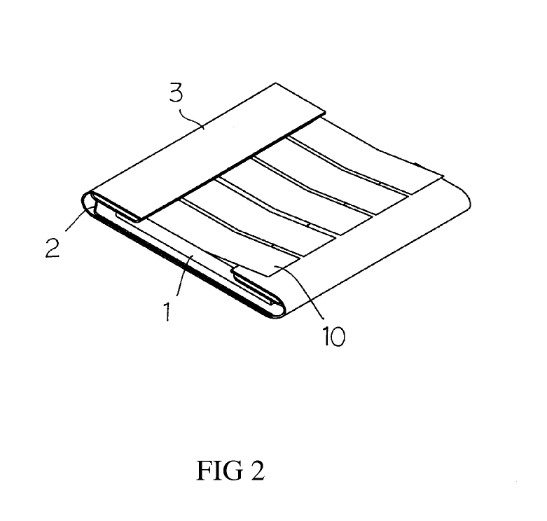

Please refer to FIG. 1 and FIG. 2. The invention is related to a self-stick-on transparent highlighter plastic film that can replace highlighter pens. The invention consists of a plastic film stack (1), an internal case (2) and an external case (3).

The self-stick-on plastic film stack (1) is made of multiple pieces of self-stick-on plastic film (10) that has fluorescene colors in red, orange, yellow, green and blue to add aesthetic and decorative effect and attraction. The self-stick-on plastic film (10) in different colors can be printed with simple symbols like arrow for users to identify different documents and replace highlighter pens with their added function and value.

As shown in FIG. 1, every piece of self-stick-on plastic film (10) sticks to its next piece of transparent highlighting plastic film (10) through adhesive (11) on one side of its bottom. The adhesive (11) is applied to the neighboring pieces of self-stick-on highlighting plastic film (10) alternatively. That means if the top piece of transparenting hlighting plastic film (10) has adhesive (11) on the left side, the bottom piece (10) will have adhesive (11) on the right side. Similarly, if the top piece of transparenting hlighting plastic film (10) has adhesive (11) on the right side, the bottom piece (10) will have adhesive (11) on the left side (11).

The internal case (2) is made of a plate with two sides curving up toward center to form a concave holder (21) and can accomodate more than one stack (1) of plastic film. The larger the internal case (2) is, the more plastic film stacks (1) are accommodated.

The external case (3) is similar in appearance but has a little larger concave holder (31) than the internal case (2). It can accomodate the internal case (2). The external case (3) and the internal case (2) can be made in different bright colors to add aesthetic effect and strong contrast to plastic film stack (1).

According to the above configuration, actual assembly is to put several self-stick on plastic film stacks (1) of different highlighting colors in parallel and stick them to the concave holder (21) of the internal case (2). Then, the topest piece of self-stick on transparent highlighting plastic film (10) for each plastic film stack (1) has its free end to stick out to the surface of the external case (3) through the concave holder (21) opening. When it is in use, depending on the user's preference in highlighting color and need, the user would peel the topest piece of self-stick-on highlighting plastic film (10) from the most proper plastic film stack (1) and put it to the document that needs special notes and can not be marked. In this way, it can replace highlighter pens and also avoid messing up the important document. Afterward, it only needs to remove the self-stick on transparent highlighting plastic film (10) to maintain the original document appearance. So it is both convenient and useful.

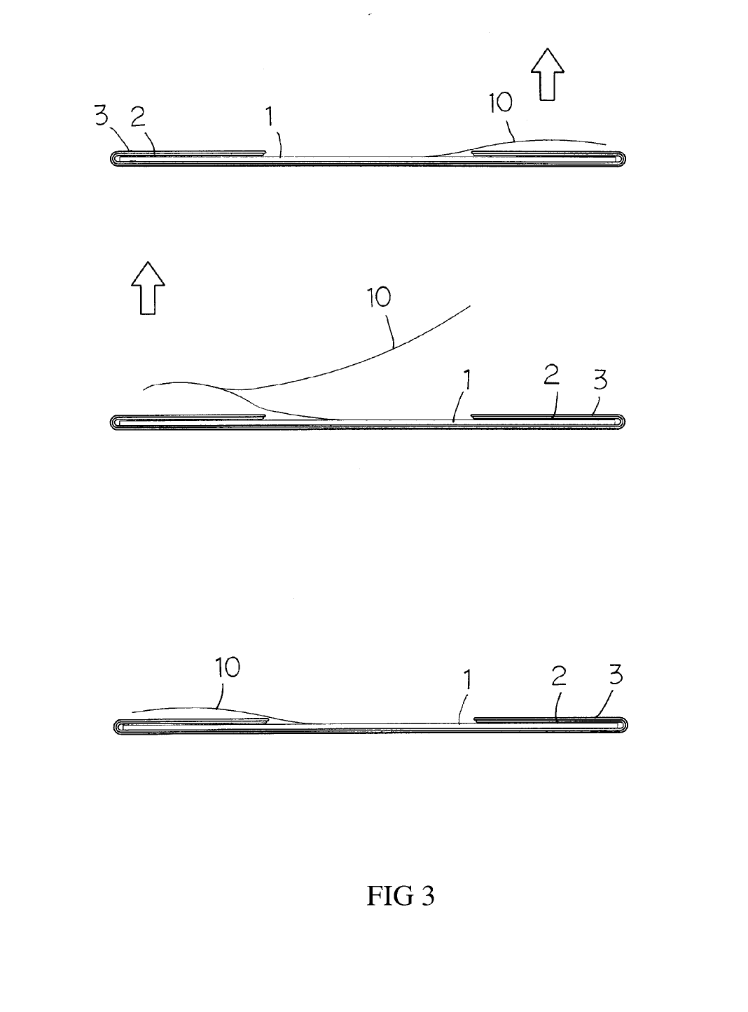

Please refer to FIG. 3 for the status of use of the self-stick-on plastic film (10) of the plastic film stack (1). Since adhesive (11) is applied to each neighboring piece of self-stick-on plastic film (10) in an alternative way, when one piece of self-stick-on plastic film (10) is peeled, the next self-stick-on plastic film (10) will be pulled out and its free end will be exposed out of the external case (3). Similarly, the entire stack of self-stick-on plastic film (10) will be used up if the same peeling is repeating.

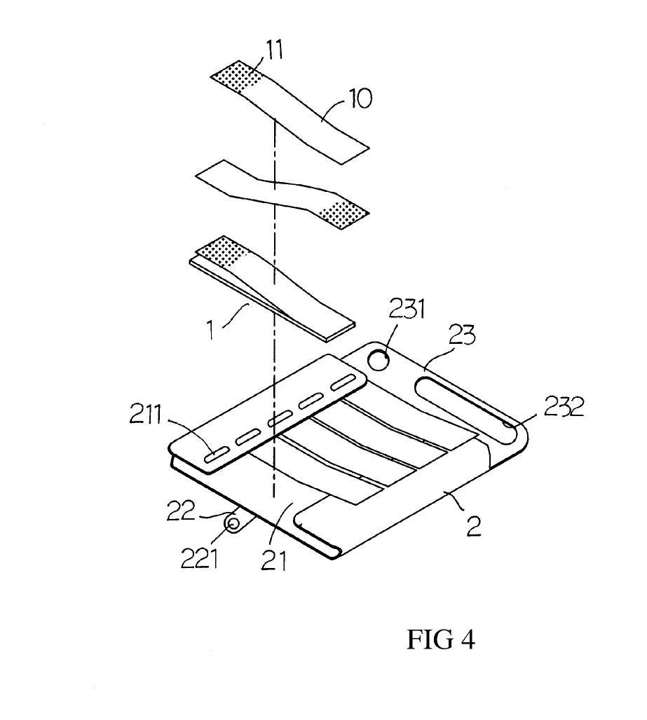

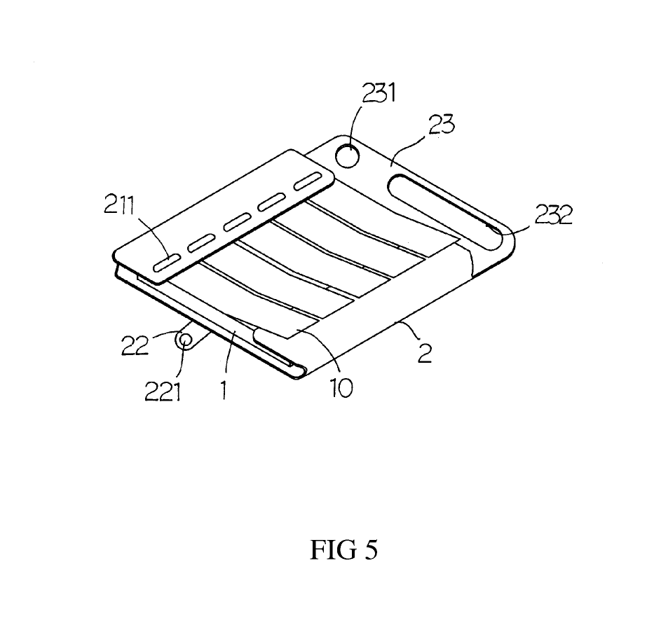

Please refer to FIG. 4 and FIG. 5. The internal case (2) or the external case (3) for the plastic film stack (1) in the invention can combine into one and be used independently. They form the configuration as in the Figures, where the internal case (2) has a hanging tab (22) with a round hole (221) and a long hanging tab (23) with a round hole (231) and a long hole (232) on the two sides. To facilitate the peeling of the self-stick-on plastic film (10), the two sides of the concave holder (21, 31) opening for the internal case (2) or the external case (3) have supportive bumps (211, 311) to match the number of the plastic film stacks (1). The bumps (211, 311) can fully support the exposing single piece of self-stick-on plastic film (10) and provide users with convenience in peeling the film. Even without looking at the self-stick-on plastic film (10), the user can easily peel it off and does not take off multiple pieces of self-stick-on plastic film (10).

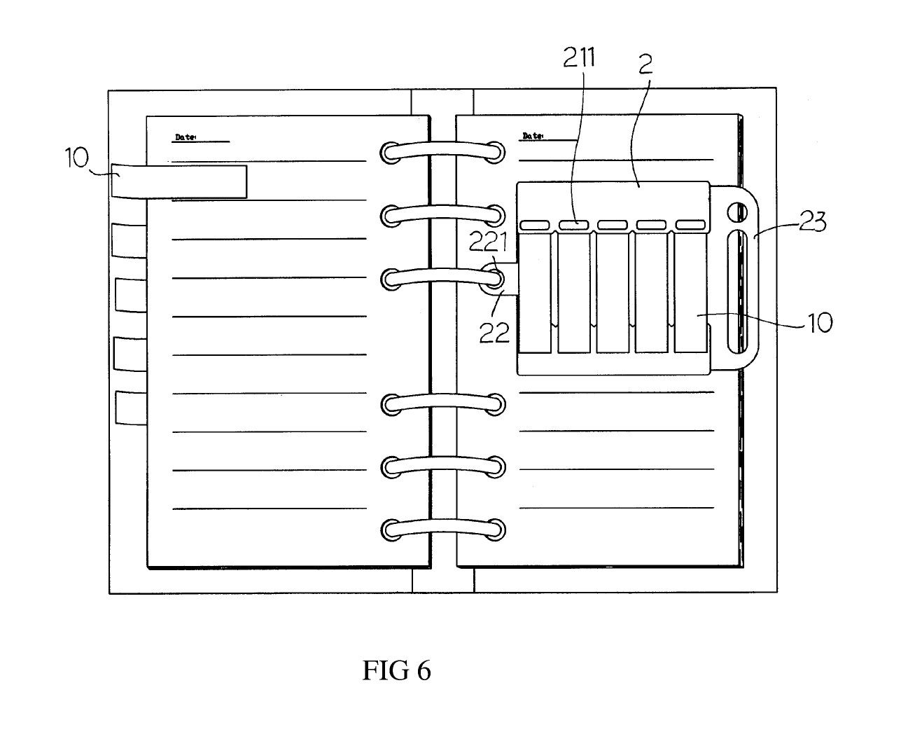

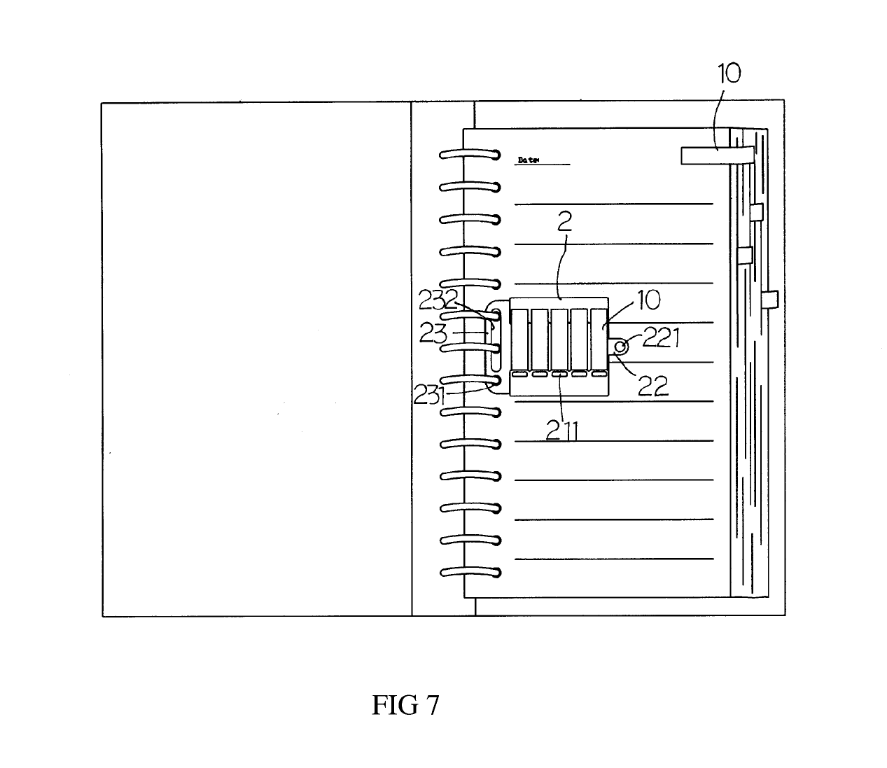

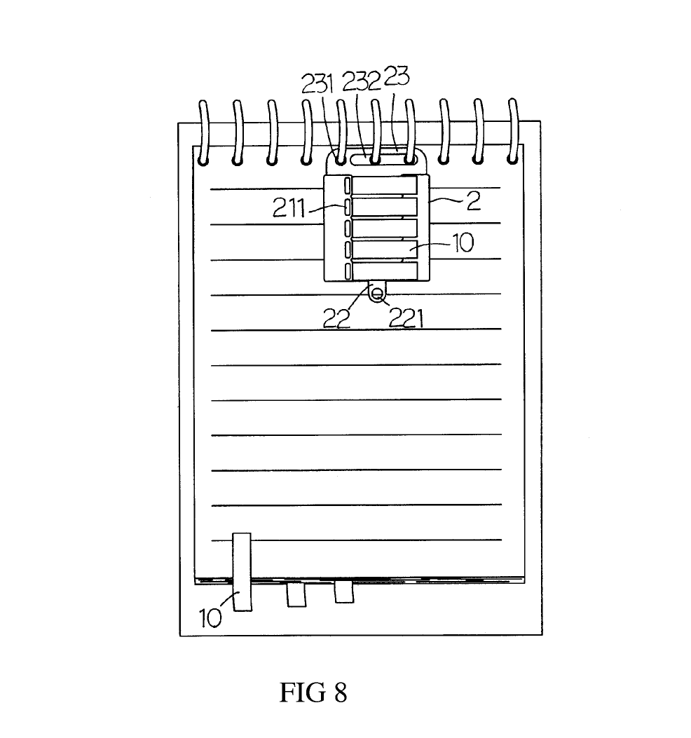

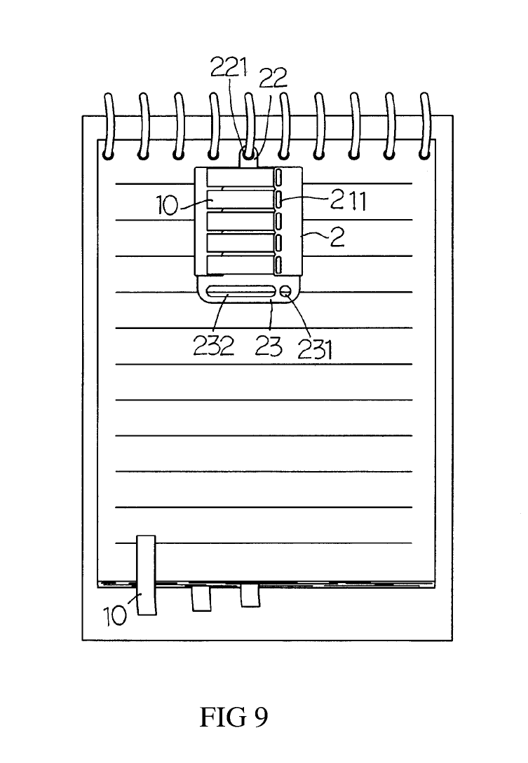

As shown from FIG. 6 to FIG. 9, the internal case (2) uses one side that has a hanging tab (22) with a single round hole (221) or another side that has a long hanging tab (23) with a round hole (231) and a long hole (232) to side to bind itself to a portable notebook or planner through spirals to achieve fixation effect and convenience of instant use. In summary, the invention is an unique new product and can not be found or published in the similar products. It meets the application requirements for new type patent and is submitted for patent approval. The above is only a preferred embodiment. Specifically, any structural modification equivalent to the content of the invention and illustrative figures is covered in the scope of the invention.

What is claimed is:

1. A self-stick-on plastic film to replace highlighter pen consists of:
a plastic film stack made of multiple pieces of self-stick-on transparent plastic film that has fluorescene colors in red, orange, yellow, green, blue and etc.;
an internal case, which is a plate with two sides curving up toward center to form a concave holder and can accommodate multiple plastic film; and
an external case, which is similar in appearance but a little larger than the internal case and can accomodate the internal case.

2. A self-stick-on plastic film to replace highlighter pen consists of:
a plastic film stack made of multiple pieces of self-stick-on transparent plastic film that has fluorescene colors in red, orange, yellow, green and blue etc.;
an internal case, which is a plate with two sides curving up toward center to form a concave holder and can accommodate more than one plastic film, and has a hanging tab with a round hole and a long hanging tab with a round hole and a long hole on the two sides.

3. As in claim 1 for a self-stick on plastic film to replace highlighter pen, the external case and the internal case can be made in different bright colors to add aesthetic effect and strong contrast to plastic film stack

4. As in claim 1 or 2 for a self-stick-on plastic film to replace highlighter pen, every piece of self-stick-on transparent plastic film sticks to its next piece of transparent highlighting plastic film through adhesive on one side of its bottom and the adhesive is applied to the neighboring pieces of self-stick transparent highlighting plastic film alternatively.

5. As in claim 1 or 2 for a self-stick-on plastic film to replace highlighter pen, the surface of the self-stick-on plastic film can be printed with simple identifiable symbols.
